(19) United States
(12) Patent Application Publication
(10) Pub. No.: US 2008/0316423 A1
(43) Pub. Date: Dec. 25, 2008

(54) COORDINATED EYEWEAR AND WATCH

(76) Inventor: Hratch Boghossian, Pompano Beach, FL (US)

Correspondence Address: CERMAK KENEALY & VAIDYA LLP, 515 E. BRADDOCK RD, SUITE B, ALEXANDRIA, VA, 22314, US

(21) Appl. No.: 11/766,270

(22) Filed: Jun. 21, 2007

(51) Int. Cl. G02C 11/00

(52) U.S. Cl. 351/158

(57) ABSTRACT

A matching eyewear and watch includes a pair of eyewear having a lens with a shape; and a wrist watch, in which the watch face has the same shape as the lens. Optionally, the eyewear lens and the watch crystal can be tinted the same, matching color.

### BACKGROUND

1. Field of Endeavor

The present invention is directed to the field of jewelry. In particular, the present invention is directed to a novel system for coordinating watch crystals and eyewear.

2. Brief Description of the Related Art

Tinted eyewear has been popular for many years. The use of tinted eyewear has typically had two principal uses: protection from the sun; and for personal fashion.

Heretofore, there has not been any attempt or effort to match eyewear with other accessories, mainly watches. Watches are a natural match for eyewear because both utilize crystals which can be both shaped and/or tinted to match each other.

There are a number of documents which are related to tinted lenses. The following are exemplary. U.S. Pat. No. 6,955,430 discloses an article of externally-worn eye wear, including, but not limited to, eyeglasses, sunglasses, goggles, and contact lenses. The eye wear includes a wavelength transmission blocker for blocking substantially all of light wavelengths throughout the blue light spectrum. The wavelength transmission blocker protects the eyes against the harmful effect of the blocked light. Also, since the eyewear is worn externally from the eye, and the user can remove the eye wear, the user can selectively block the light. As such, the eyewear can be worn to block potentially harmful light, or the eyewear can be removed if blocking the light would cause other hazards.

U.S. Pat. No. 6,231,100 discloses an interactive eyewear selection system including: a video camera and digitizing system for acquiring a digital image of a person's face, including the temple areas of the face; an eyeglass frames database for storing digital eyeglass frame images; an automated interface for selecting an eyeglass frame image from the frames database, the image containing frame temple portions; a digital processing system for automatically superimposing the selected frame image on the image of the person's face, in a composite image, such that the frame appears to be worn naturally on the person's face and the frame temple portions are shown at the temple areas of the face; and a display device for displaying the digital image of the person's face and for displaying the composite image.

U.S. Pat. No. D400, 223 shows a combined case and tinted lens coverings.

U.S. Pat. No. 4,259,406 discloses that selectively tinted photochromic glass lenses, such as photochromic lenses with a fixed tint gradient in transmittance, ranging from a dark tint at the top of the lens to pale or no tinting at the bottom of the lens, are provided by a process including surface coloration and subsequent selective colored surface layer removal, without introducing optical aberrations into the lenses.

It would be desirable to provide a system for matching eyewear with watch crystals.

### SUMMARY

According to a first aspect of the invention, a set eyewear and watch includes a set of eyewear having a lens with a lens shape; and a wrist watch having a watch face, the watch face having the same shape as the lens shape.

According to another aspect of the present invention, a matching eyewear and watch includes: a set of eyewear having a lens with a first tinted color; and a wrist watch having a crystal, wherein the watch crystal has the same tinted color as the eyewear lens.

According to yet another aspect of the present invention, matching eyewear and watch includes: a set of eyewear having a lens with a lens shape and a tinted color; and a wrist watch having a watch face with a crystal, wherein the watch face has the same shape as the lens shape and the lens has the same tinted color as the wrist face crystal.

Still other aspects, features, and attendant advantages of the present invention will become apparent to those skilled in the art from a reading of the following detailed description of embodiments constructed in accordance therewith, taken in conjunction with the accompanying drawings.

### BRIEF DESCRIPTION OF THE DRAWINGS

The invention of the present application will now be described in more detail with reference to exemplary embodiments of the apparatus and method, given only by way of example, and with reference to the accompanying drawings, in which:

FIG. 1 illustrates a first exemplary embodiment of the eyewear and a watch.

FIG. 2 illustrates a second exemplary embodiment of eyewear and a watch.

FIG. 3 illustrates a third exemplary embodiment of eyewear and a watch.

FIG. 4 illustrates a fourth exemplary embodiment of eyewear and a watch.

### DETAILED DESCRIPTION OF EXEMPLARY EMBODIMENTS

Referring to the drawing figures, like reference numerals designate identical or corresponding elements throughout the several figures.

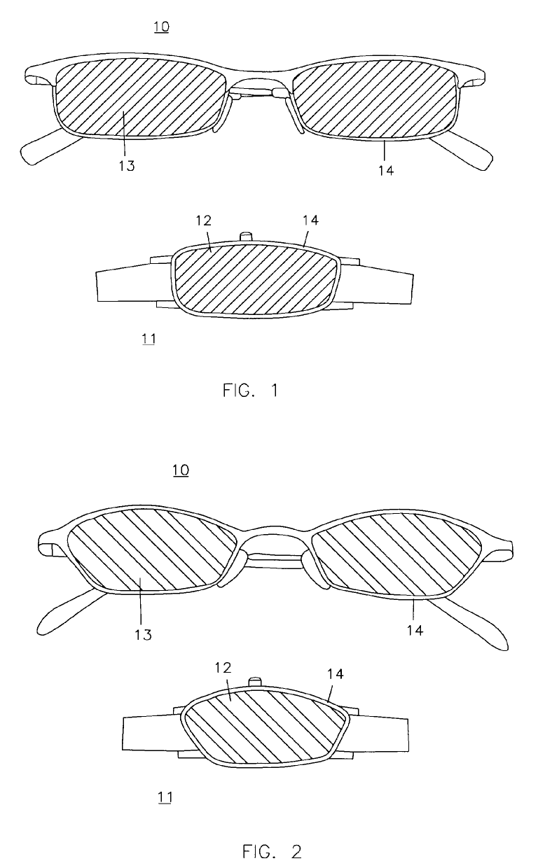

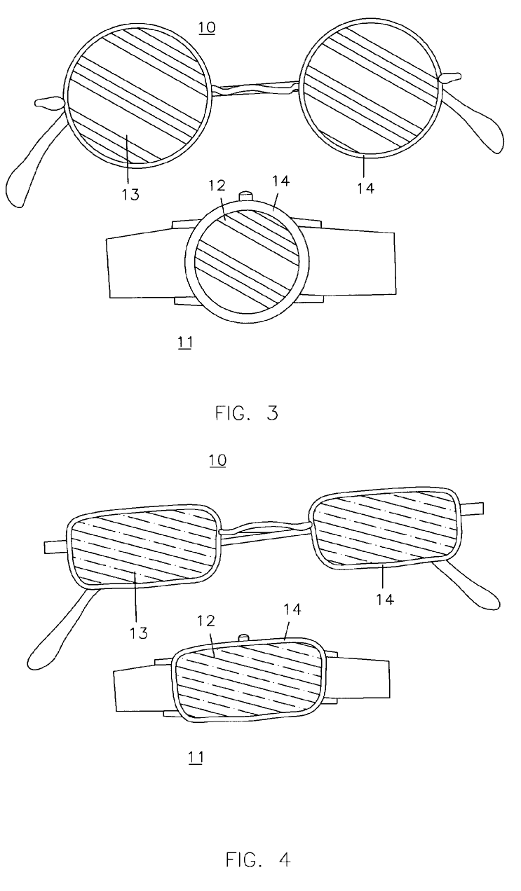

Exemplary embodiments adhering to principles of the present invention are described with reference to the attached figures. Referring to FIG. 1, a pair of the eyeglasses 10 is illustrated with a matching watch 11, including a watch face crystal 12. In each of the exemplary embodiments illustrated in FIGS. 1-4, the eyeglass lenses 13 are tinted and the watch crystals 12 have an identical tint. In addition or as an alternative to having matching tints, the watch face crystal 12 has a shape 14 which tracks, matches, or is identical to the shape 14 of the eyewear lenses. Further optionally, the sizes of the watch crystal 12 and lenses 13 can be identical, in addition to their shapes being the same.

While it is envisioned that the watch and eyeglasses will be displayed, sold, and/or worn by a user as a pair, the invention is not limited to their co-display. In the context of the present invention, eyeglasses include eyewear types both with and without portions of the frames which are configured to extend over the ear of the wearer, e.g., includes pince nez eyewear and monocles, and watches includes types both with and without a wrist band, e.g., includes wristwatches, pendent watches (those worn with a necklace), and pocket watches.

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What I claim is:

1. An eyewear and watch set comprising:
a set of eyewear having a lens with a lens shape; and
a wrist watch having a watch face, the watch face having the same shape as the lens shape.

2. A matching eyewear and watch comprising:
a set of eyewear having a lens with a first tinted color; and
a wrist watch having a crystal, wherein the watch crystal has the same tinted color as the eyewear lens.

3. A matching eyewear and watch comprising:
a set of eyewear having a lens with a lens shape and a tinted color; and
a wrist watch having a watch face with a crystal, wherein the watch face has the same shape as the lens shape and the lens has the same tinted color as the wrist face crystal.
